(19) United States
(12) Patent Application Publication
(10) Pub. No.: US 2013/0265151 A1
(43) Pub. Date: Oct. 10, 2013

(54) Method for monitoring an object and use of a sensor to monitor an object

(71) Applicant: Christian BRAEUCHLE, Hassmersheim Hochhausen (DE)

(72) Inventor: Christian BRAEUCHLE, Hassmersheim Hochhausen (DE)

(73) Assignee: Robert Bosch GmbH, Stuttgart (DE)

(21) Appl. No.: 13/854,512

(22) Filed: Apr. 1, 2013

(30) Foreign Application Priority Data
Apr. 5, 2012 (DE) 102012205663.7

(51) Int. Cl. B60Q 9/00

(52) U.S. Cl. CPC B60Q 9/008
USPC 340/435

(57) ABSTRACT

A method for monitoring an object, especially for monitoring a real property, in which by a sensor of a vehicle, particularly a sensor of a motor vehicle, the object itself, different from the vehicle, and/or a surrounding area of the object different from the vehicle is monitored. Also described is a use of a sensor to monitor an object, especially to monitor a real property, the sensor being a sensor of a vehicle, particularly of a motor vehicle, and the object to be monitored being different from the vehicle. Also described is a sensor, a sensor system, an alarm system or a vehicle, especially a motor vehicle, a method as described being executable with the sensor, the sensor system, the alarm system or the vehicle, or the sensor, the sensor system, the alarm system or the vehicle being used according to the method and/or system.

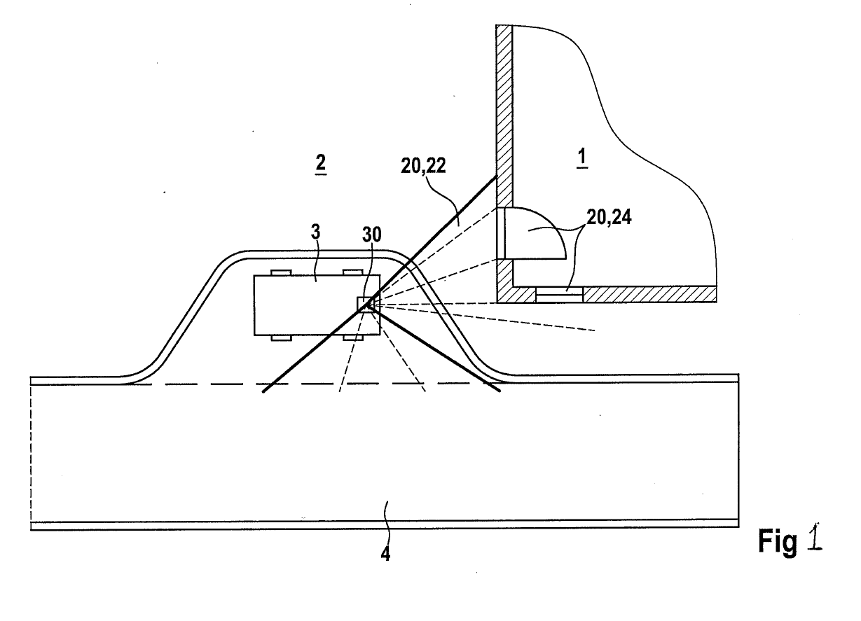

### RELATED APPLICATION INFORMATION

The present application claims priority to and the benefit of German patent application no. 10 2012 205 663.7, which was filed in Germany on Apr. 5, 2012, the disclosure of which is incorporated herein by reference.

### FIELD OF THE INVENTION

The present invention relates to a method for monitoring an object, particularly for monitoring a real property. The present invention further relates to a use of a sensor to monitor an object, particularly to monitor a real property. In addition, the present invention relates to a sensor, a sensor system, an alarm system or a vehicle, especially a motor vehicle.

### BACKGROUND INFORMATION

Motor vehicles are increasingly being equipped with sensors for recording, thus for sensing or detecting, an area surrounding the motor vehicle, so that various driver-assistance functions are able to be realized. In more and more motor vehicles, such a vehicle sensor system is part of the standard features. Such sensors suitable for the vehicle sensor system are radar, video, laser or ultrasonic sensors, for example. In addition, combined under the term Car-to-X communication in the related art are methods which describe a data exchange among motor vehicles or between a motor vehicle and another receive/transmit station. Furthermore, in the related art, motion sensors and/or video cameras are used on and in buildings for safeguarding objects in order to monitor them and protect them from burglary, damage, etc.

### SUMMARY OF THE INVENTION

An object of the exemplary embodiments and/or exemplary methods of the present invention is, with the aid of a vehicle, especially a motor vehicle, to create an added value for an owner or user of the vehicle in such a way that the vehicle is able to fulfill a useful function even in a stationary phase and not just stand having no added value. It is further an object of the present invention to indicate an improved method for monitoring an object, especially an improved method for monitoring a real property. In addition, an object of the present invention is to provide an improved real-property alarm system having at least one sensor, as well as a sensor, a sensor system, an alarm system or a vehicle, especially a motor vehicle.

The object of the present invention may be achieved by a method for monitoring an object, especially for monitoring a real property, according to the description herein; by a use of a sensor to monitor an object, especially to monitor a real property, according to the description herein; with the aid of a real-property alarm system having at least one sensor, according to the description herein; and with the aid of a sensor, a sensor system, an alarm system or a vehicle, especially a motor vehicle, according to the description herein. Advantageous further refinements, additional features and/or advantages of the present invention are derived from the following description.

In the case of the method of the present invention for monitoring the object, the object itself, different from a vehicle, and/or an area surrounding the object different from a vehicle is monitored by a sensor of the vehicle, especially a sensor of a motor vehicle. In the case of the use of a sensor to monitor the object according to the present invention, the sensor is a sensor of a vehicle, especially of a motor vehicle, the object to be monitored being different from the vehicle. The real-property alarm system of the present invention is set up in such a way that a sensor of a vehicle is able to act, at least intermittently, as a sensor of the real-property alarm system. Furthermore, a method according to the present invention is able to be realized with the aid of the sensor, the sensor system, the alarm system or the vehicle, i.e., the sensor, the sensor system, the alarm system or the vehicle is usable according to the present invention.

An aspect of the present invention is the use of a surround sensor system of a vehicle to monitor one or a plurality of specific areas of an object, e.g., a building, a home, etc. One advantage lies in the use of the vehicle during its standing phases and in a cost-effective realization of an alarm system, particularly a house-alarm system, utilizing the vehicle sensor system. According to the present invention, in general, any determined, stationary or perhaps moving object is able to be monitored by one or a plurality of vehicles, possibly in cooperation with a system like an alarm system external to the vehicle or vehicles. In particular, a system already existing is able to be expanded by the suitable sensor(s) of the vehicle sensor system.

In this context, for example, the vehicle may be parked in a parking space and the real property or properties in question may be monitored by a surround sensor system of the vehicle. Furthermore, the vehicle may be located in a garage, a carport, etc., thus in the object to be monitored itself. In this case, no restriction of the system features ensues; the vehicle sensor system may continue to be used as a motion detector or an alarm device.

According to the present invention, a sensor may also be understood to be a detector. In addition, instead of the sensor, a sensor system or a portion of the sensor system of the vehicle may be used; the sensor system may include a plurality of sensors and/or detectors. In this connection, a plurality of sensors or detectors of the sensor system may be sensors and detectors, respectively, which operate with the same, similar or different principles. Moreover, a sensor may also be understood to be a unit or a device which has a device or apparatus corresponding to it for evaluating a signal and/or to output a reaction pattern.

According to the present invention, the object and/or the surroundings of the object may be monitored when the vehicle is stationary and/or immobilized; for example, the vehicle (electric vehicle or hybrid vehicle) may be in/at a recharging station. The sensor itself and/or a suspension mount of the sensor on/in the vehicle may be set up such that the sensor is able to be aligned with the object and/or the area surrounding the object in such a way that the object and/or the area surrounding the object is/are able to be sensed. According to the present invention, the object itself is able to be monitored directly, and/or an immediate and/or a non-immediate area surrounding the object is able to be monitored. An access area to the object, especially a street, a walk or a garden, and/or an entry area of the object, especially a door, a window and/or a shaft may be monitored.

Upon sensing or detecting something out of the ordinary, possibly after filtering, an active and/or passive reaction pattern may be output or ensues. The reaction pattern may be in the form of an alarm, a recording and/or a notification, with a light, a horn, a motor, a camera, a recording device and/or an alarm system of the vehicle or of a real property being put into operation. The signal from the vehicle sensor, conditioned if necessary, may be made available to a device external to the vehicle, especially to an external alarm system. The signal of the vehicle sensor may be used as a single or an additional sensor signal for the external device, particularly the external alarm system.

In specific embodiments of the present invention, the vehicle may act as a motion detector, with a light, especially a headlight, of the vehicle and/or a warning device being activated in response to a sensed or detected motion. If a connection to a receive station is available, in response to the sensed or detected motion, a signal may be sent to the receive station, based on which, a reaction pattern, external with respect to the vehicle, is controlled. In addition, with the aid of a video sensor system of the vehicle, a video signal may be transmitted to a receive station, especially a receive station within the object, the video signal may be able to be displayed on a monitor in real time.

In one development of the present invention, a mode of operation as a motion detector, also within a garage, etc., may additionally or perhaps instead be used as a “comfort function” and not (only) as an alarm or warning device. For example, the outside lighting may be triggered, comparable to a commercial motion detector. Alternatively, a lighting device of the vehicle may also be triggered, in order to illuminate a certain area.

According to the present invention, the sensor may be a surround sensor or a surround detector of the vehicle, the surround sensor or surround detector may be a motion sensor, a motion detector, an IR-sensor, a fire sensor, a radar sensor, a rain sensor, an acceleration sensor, a video camera, a laser sensor and/or an ultrasonic sensor. Furthermore, according to the present invention, a plurality of sensors of a single vehicle and/or a plurality of vehicles may be used to monitor the object and/or to monitor the area surrounding the object.

In the following, the present invention is explained in greater detail on the basis of exemplary embodiments with reference to the single attached FIGURE.

### BRIEF DESCRIPTION OF THE DRAWINGS

In a plan view, this FIGURE shows an access area and entry area of a real property which, according to the present invention, is/are able to be monitored by a sensor or a sensor system of a vehicle, especially a motor vehicle.

### DETAILED DESCRIPTION

The specific embodiments of the present invention described in the following relate to the monitoring and/or protection of a real property or a building by a motor vehicle. However, the present invention is not limited to the monitoring or protection of real property, but rather, may be used on objects in the most general sense. Thus, for example, according to the present invention, it is possible to monitor any desired locality such as a place, a garden, etc., but also, for instance, an object lingering at the moment in a specific area, such as a child spending time in a playground. In addition, the term to monitor is also intended to include the term to protect.

The figure shows a vehicle 3, especially a motor vehicle 3, which is parked in a parking space next to a walk 4 or a street 4, and is used to monitor and/or to protect an object 1, especially a real property 1 or a building 1. For this, motor vehicle 3 monitors what may be an immediate surrounding area 2 of object 1 and/or object 1 itself and/or an area surrounding motor vehicle 3. Motor vehicle 3 monitors object 1 with the aid of a sensor 30 or detector 30, especially a surround sensor 30 or a surround detector 30 which is mounted or provided in/on motor vehicle 3 and which may be part of a sensor system of motor vehicle 3. For example, sensor 30 or detector 30 may be a motion sensor 30, a motion detector 30, an IR-sensor 30, a fire sensor 30, a radar sensor 30, a rain sensor 30, an acceleration sensor 30, a video camera 30, a laser sensor 30, an ultrasonic sensor 30, etc.

According to the present invention, sensing or detecting is carried out for object 1 itself, that is, surrounding area 2; 20, 22, 24 of object 1 is sensed and not the surrounding area relevant for the vehicle itself. Thus, a relevant surrounding area 20, 22, 24 of the object is sensed or detected. Relevant surrounding area 20, 22, 24 of an object follows from an interest of the one who wants to monitor or protect object 1; relevant surrounding area 20, 22, 24 of the object is to be differentiated from the relevant surrounding area of the vehicle. The relevant surrounding area of the vehicle lies in the interest of the one who controls the vehicle during its operation; the relevant surrounding area of the vehicle changes constantly in terms of a map, for example, and pertains essentially to the areas changing locally in front of and in back of the vehicle. On the other hand, relevant surrounding area 20, 22, 24 of the object is non-transportable and bound to object 1 and, if desired, may be marked in on a map.

Relevant surrounding area 20 of the object may be an immediate 24 and/or non-immediate surrounding area 22 of object 1; for example, non-immediate surrounding area 22 of object 1 may be an access area such as street 4, walk 4 or a garden in the case of object 1. Immediate surrounding area 24 of object 1 is an entry area of object 1, such as a door, a window or a shaft of object 1, for instance. Immediate surrounding area 24 of object 1 is also to be understood as object 1 itself, thus, essentially its outer boundary.

In this context, object 1 may be monitored by vehicle 3 alone, or vehicle 3 may cooperate with a device of object 1, particularly an alarm system of object 1, sensor 30 or sensors (sensor system) 30 of vehicle 3 cooperating with the device of object 1. In doing this, vehicle 3 or sensor 30 in question makes a signal available to the device of object 1. If necessary, the signal of respective sensor 30 may be filtered and/or conditioned, in doing which, the signal may be adapted to the internal conditions of the device of object 1, thus, particularly to the alarm system.

In the following, exemplary implementations of monitoring with the aid of a vehicle 3, or rather with the aid of a sensor 30 or a sensor system of vehicle 3, are explained in greater detail.

However, the present invention is not limited to such specific embodiments, but rather, can, of course, take on a multitude of other forms.—Thus, for example, it is possible for vehicle 3 to act as a motion detector, for instance, in a private backyard (object 1) or a building adjacent to it (object 1). For instance, in response to a detected motion, e.g., by an IR-sensor 30 or a radar sensor 30, a headlight of vehicle 3, similar to an outside light with a motion detector, or a warning device may be put into operation, possibly together with a warning device of an alarm system of the building in question. This may be carried out commensurate with an ambient brightness of a location of the vehicle (day, night, garage, carport, etc.).

In addition, this may be expanded by a data connection (Car-to-X interface of a Car-to-X communication) to object 1 to be monitored, thus, to the building located adjacent to the backyard, or to a central coverage station for monitoring a number of buildings. In this case, it may be signaled to a receive station, e.g., within the building or in the central coverage station, that a motion was detected.—If vehicle 3 has a video sensor system, a video signal may be transmitted to the receive station, e.g., in object 1 to be monitored, and be displayed on a monitor in real time, for example. An IR-camera is suitable for monitoring during poor lighting conditions or at dusk or at night.—According to the present invention, corresponding to the examples previously described, it is possible to couple a plurality of vehicles 3 and/or a sensor system already existing, e.g., a house alarm system.

In general, it is possible to realize a data exchange and/or signal exchange through the Car-to-X communication. Moreover, a multitude of other possibilities are conceivable to realize it with the aid of data-transmission devices. Thus, for example, it is possible to realize it via a mobile radio network, an Internet link, cloud computing, LTE (Long Term Evolution) networks, etc. There is also the possibility of a cabled communication, which typically does not fall under the term Car-to-X. It may be realized both by a separate connection, and in combination with the link itself, as exists in any case, for example, for the charging of an electric vehicle, a hybrid vehicle, etc.

What is claimed is:

1. A method for monitoring an object, the method comprising:
monitoring, by a sensor of a vehicle, at least one of how the object itself is different from the vehicle, and how a surrounding area of the object is different from the vehicle.

2. A method for monitoring an object, which is a real property, the method comprising:
monitoring, by a sensor of a motor vehicle, at least one of how the object itself is different from the motor vehicle.

3. The monitoring method of claim 1, wherein at least one of the object and the surrounding area of the object is monitored when the vehicle is at least one of stationary and immobilized, and wherein at least one of the sensor itself and a suspension mount of the sensor is set up on or in the vehicle, such that the sensor is alignable with at least one of the object and the surrounding area of the object so that at least one of the object and the surrounding area of the object is able to be sensed.

4. The monitoring method of claim 1, wherein the object itself is monitored directly and/or an immediate and/or a non-immediate surrounding area of the object is monitored, wherein in particular, an access area to the object, including a street, a walk or a garden, and/or, in particular, an entry area of the object, including a door, a window and/or a shaft, is monitored.

5. The monitoring method of claim 1, wherein upon sensing or detecting something out of the ordinary, including after filtering, an active and/or passive reaction pattern is output or ensues, and the reaction pattern is in the form of an alarm, a recording and/or a notification, with a light, a horn, a motor, a camera, a recording device or an alarm system of the vehicle being put into operation.

6. The monitoring method of claim 1, wherein a signal of the sensor of the vehicle, conditioned if necessary, is made available to a device external to the vehicle, including to an external alarm system, the signal of the sensor of the vehicle being used as a single or as an additional sensor signal of the external device, including the external alarm system.

7. The monitoring method of claim 1, wherein the vehicle acts as a motion detector, with a light, including a headlight of the vehicle and/or a warning device being activated in response to a sensed or detected motion, and/or given the existence of a connection to a receive station, in response to the sensed or detected motion, which is a signal is sent to the receive station, based on which, a reaction pattern, external with respect to the vehicle, is controlled, and/or with the aid of a video sensor system of the vehicle, a video signal is transmittable to a receive station, including a receive station within the object, and the video signal is displayable on a monitor in real time.

8. The monitoring method of claim 1, wherein the sensor is a surround sensor or a surround detector of the vehicle.

9. The monitoring method of claim 1, wherein a plurality of sensors of a single vehicle and/or a plurality of vehicles are used to monitor the object and/or to monitor the surrounding area of the object.

10. The monitoring method of claim 1, wherein at least one of the following is satisfied:
the sensor is a detector,
instead of the sensor, a sensor system of the vehicle is used, the sensor system including a plurality of sensors and/or detectors,
a plurality of sensors or detectors of the sensor system are sensors or detectors which operate with the same, similar or different principles, and
one sensor has or is assigned a device or apparatus corresponding to it to evaluate its signal.

11. A real-property alarm system, comprising:
at least one sensor, wherein the real-property alarm system is set up so a sensor of a vehicle is able to act intermittently as a sensor of the real-property alarm system.

12. The method of claim 1, wherein the sensor is realized using one of a sensor device, a sensor system, an alarm system of the vehicle.

13. The monitoring method of claim 1, wherein the surround sensor or the surround detector includes a motion sensor, a motion detector, an IR-sensor, a fire sensor, a radar sensor, a rain sensor, an acceleration sensor, a video camera, a laser sensor, or an ultrasonic sensor.
